(19) United States
(12) Patent Application Publication
(10) Pub. No.: US 2022/0326022 A1
(43) Pub. Date: Oct. 13, 2022

(54) SPEED-BASED TRAJECTORY REDUCTION METHOD AND DEVICE FOR REDUCING TRAJECTORY DATA ACCORDING TO SPEEDS OF TRAJECTORY POINTS

(71) Applicant: LSC Ecosystem Corporation, Taoyuan City (TW)

(72) Inventors: Wei-Ming Li, New Taipei City (TW); Ming-Hsuan Kuo, New Taipei City (TW); Sung-Ching Lin, New Taipei City (TW)

(73) Assignee: LSC Ecosystem Corporation, Taoyuan City (TW)

(21) Appl. No.: 17/714,159

(22) Filed: Apr. 6, 2022

Related U.S. Application Data
(60) Provisional application No. 63/172,048, filed on Apr. 7, 2021.

(30) Foreign Application Priority Data
Oct. 1, 2021 (TW) 110136756

(51) Int. Cl. G01C 21/28

(52) U.S. Cl. CPC G01C 21/28

(57) ABSTRACT

The speed-based trajectory reducing method and device can be used to obtain trajectory data of a trajectory, obtain the speed of each trajectory point of a plurality of trajectory points of the trajectory data, determine at least one anchor point from the plurality of trajectory points according to the speeds of the plurality of trajectory points, divide the trajectory into at least one trajectory segment according to the at least one anchor point, perform downsampling with a plurality of trajectory points of each trajectory segment to generate a downsampling result, and delete some trajectory points and retain at least the at least one anchor point to update the trajectory data. By deleting the trajectory points and appropriately retaining information of speed, the amount of data stored, processed and transmitted can be reduced while maintaining sufficient accuracy.

### CROSS REFERENCE TO RELATED APPLICATIONS

This application claims the benefit of U.S. Provisional Application No. 63/172,048, filed on Apr. 7, 2021. The content of the application is incorporated herein by reference.

### BACKGROUND OF THE INVENTION

### 1. Field of the Invention

The invention is related to a trajectory reduction method and a trajectory reduction device, and more particularly, a speed-based trajectory reduction method and a speed-based trajectory reduction device used for reducing trajectory data according to speeds of trajectory points.

### 2. Description of the Prior Art

With the widespread application of positioning technology, the trajectory of a moving object (such as a vehicle) can be recorded by means of global positioning system. The trajectory data can be uploaded to the cloud server to be stored and analyzed.

However, with the continuous accumulation of the trajectory data, it is difficult to reduce the amount of trajectory data and network transmission. The huge amount of trajectory data will require longer transmission time, higher network cost, and larger storage space, leading to a negative impact.

In addition, when analyzing the information of the moving object, in addition to the trajectory, the relevant information of the moving speed is also important. However, at present, there is no suitable solution for reducing the amount of trajectory data while properly retaining the relevant information of speed.

### SUMMARY OF THE INVENTION

An embodiment provides a trajectory reduction method, including obtaining trajectory data of a trajectory, where the trajectory data includes a plurality of trajectory points; obtaining a speed of each trajectory point of the trajectory data; determining at least one anchor point from the plurality of trajectory points according to speeds of the plurality of trajectory points; dividing the trajectory into at least one trajectory segment according to the at least one anchor point; downsampling a plurality of trajectory points of each trajectory segment to generate a downsampling result; and updating the trajectory data of the trajectory by retaining at least the at least one anchor point in the trajectory data of the trajectory according to the downsampling result.

Another embodiment provides a trajectory reduction device including a positioning unit, a speed calculation unit, an anchor determination unit, a downsampling unit and a trajectory update unit. The positioning unit is used to collect a plurality of trajectory points of trajectory data of a trajectory. The speed calculation unit is linked to the positioning unit, and used to calculate a speed of each trajectory point of the trajectory data. The anchor determination unit is linked to the speed calculation unit, and used to determine at least one anchor point from the plurality of trajectory points according to speeds of the plurality of trajectory points, and divide the trajectory into at least one trajectory segment according to the at least one anchor point. The downsampling unit is linked to the anchor determination unit, and configured to downsample a plurality of trajectory points of each trajectory segment to generate a downsampling result. The trajectory update unit is linked to the downsampling unit, configured to update the trajectory data by retaining at least the at least one anchor point in the trajectory data of the trajectory according to the downsampling result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a flowchart of a trajectory reduction method according to an embodiment.

FIG. 2 illustrates an example of trajectory data before being reduced using the method of FIG. 1.

FIG. 3 illustrates an example of trajectory data after being reduced using the method of FIG. 1.

FIG. 4 illustrates a flowchart of determining the anchor points from the plurality of trajectory points in FIG. 1.

FIG. 5 illustrates the relationship between the speed threshold and the number of the trajectory segments according to an embodiment.

FIG. 6 illustrates a flowchart of downsampling each trajectory segment to retain or delete trajectory points according to an embodiment.

FIG. 7 illustrates an example where the trajectory points are within a predetermined range.

FIG. 8 illustrates an example where one trajectory point is outside the predetermined range while other trajectory points are within the predetermined range.

FIG. 9 illustrates a trajectory reduction device according to an embodiment.

### DETAILED DESCRIPTION

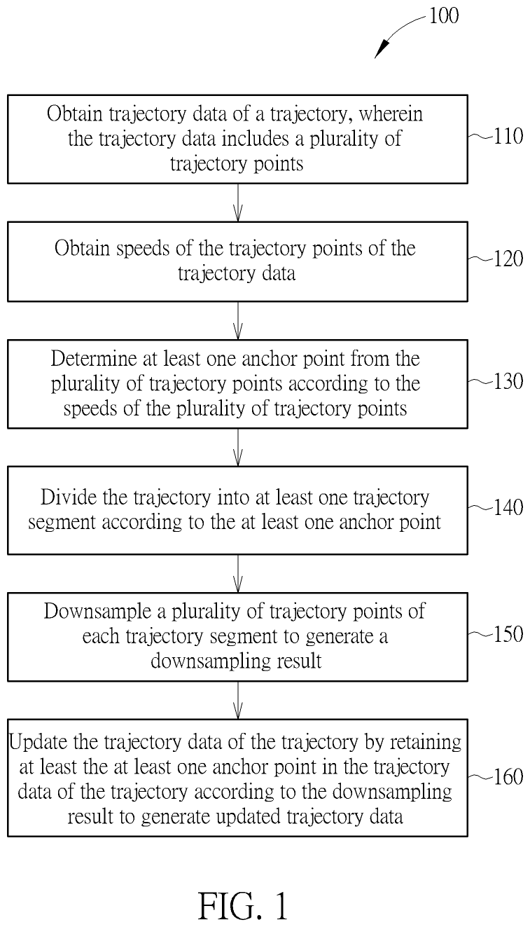

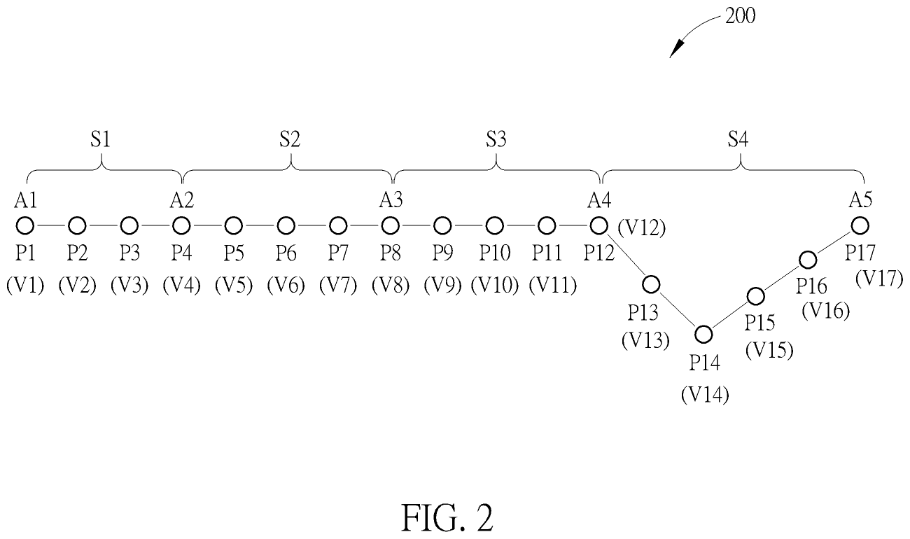

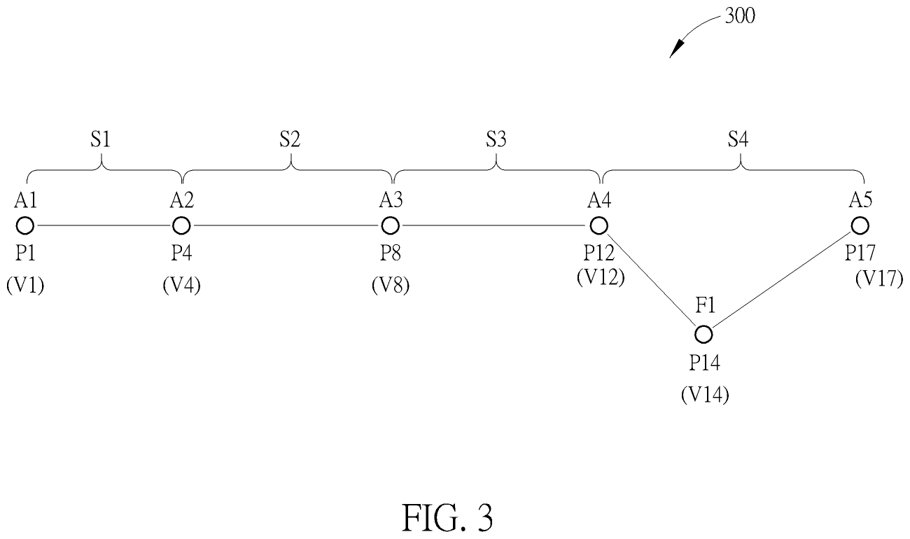

In order to deal with the abovementioned problem in the field, a trajectory reduction method and a trajectory reduction device are provided as below. FIG. 1 illustrates a flowchart of a trajectory reduction method 100 according to an embodiment. FIG. 2 and FIG. 3 illustrate an example for explaining the trajectory reduction method 100 of FIG. 1. The trajectory data 200 of FIG. 2 is the data before being reduced, and the trajectory data 300 of FIG. 3 is generated using trajectory reduction method 100 of FIG. 1 to process the trajectory data 200 of FIG. 2. Taking FIG. 2 and FIG. 3 as an example, the method 100 can include the following steps.

Step 110: obtain trajectory data 200 of a trajectory, wherein the trajectory data 200 includes a plurality of trajectory points P1 to P17;

Step 120: obtain speeds V1 to V17 of the trajectory points of the trajectory data 200;

Step 130: determine at least one anchor point A1 to A5 from the plurality of trajectory points P1 to P17 according to the speeds V1 to V17 of the plurality of trajectory points P1 to P17;

Step 140: divide the trajectory into at least one trajectory segment S1 to S4 according to the at least one anchor point A1 to Ax5;

Step 150: downsample a plurality of trajectory points of each trajectory segment to generate a downsampling result; and

Step 160: update the trajectory data 200 of the trajectory by retaining at least the at least one anchor point A1 to A5 in the trajectory data 200 of the trajectory according to the downsampling result to generate updated trajectory data 300.

As expressed in Step 110 and FIG. 2, when an object (e.g., vehicle) moves, the locations of the object can be sampled to obtain the plurality of trajectory points P1 to P17 of the trajectory data 200.

As expressed in Step 120 and FIG. 2, when the object moves through each trajectory point, there is a corresponding speed, hence the trajectory points P1 to P17 can be respectively related to the speeds V1 to V17.

As expressed in Step 130 and FIG. 2, the trajectory points P1, P4, P8, P12 and P17 can be respectively selected to be the anchor points A1, A2, A3, A4 and A5. The selection of the anchor points is described below.

As expressed in Step 140 and FIG. 2, the trajectory can be divided into the trajectory segment S1 to S4 according to the anchor points A1 to A5 determined in Step 130. The trajectory segment S1 is between the anchor points A1 and A2. The trajectory segment S2 is between the anchor points A2 and A3. The trajectory segment S3 is between the anchor points A3 and A4. The trajectory segment S4 is between the anchor points A4 and A5.

FIG. 2 is one example. According to another example, a trajectory may contain only one anchor point and not be divided into two or more trajectory segments. If a trajectory includes only one anchor point, the trajectory can include only one trajectory segment, and a last trajectory point of the trajectory can be retained.

As described in Steps 150 and 160, the plurality of trajectory points in each of the trajectory segments can be downsampled to retain or delete the trajectory points other than the anchor points to generate the downsampling result. The operation related to the downsampling is described below.

As described in Step 160, in the reduced trajectory data (e.g., the data 300 of FIG. 3), at least the anchor points (e.g., A1 to A5) determined in Step 130 should be retained. The trajectory points other than the anchor points can be further checked. If a trajectory point other than the anchor points is determined to be a feature point, it can be retained. On the contrary, if a trajectory point other than the anchor points is determined not to be a feature point, it can be deleted for the purpose of reducing the trajectory data. The determination of a feature point is described below.

In the example of FIG. 2 and FIG. 3, after downsampling the trajectory points, the trajectory points P2 and P3 of the trajectory segment S1, the trajectory points P5 to P7 of the trajectory segment S2, the trajectory points P9 to P11 of the trajectory segment S3, the trajectory points P13, P15 and P16 of the trajectory segment S4 can be deleted. The anchor points A1, A2, A3, A4 and A5 (i.e. the trajectory points P1, P4, P8, P12 and P17) and the feature point F1 (i.e. the trajectory point P14) can be retained to generate the trajectory data 300 of FIG. 3. Hence, the trajectory data 300 can be generated by reducing the trajectory data 200 of FIG. 2.

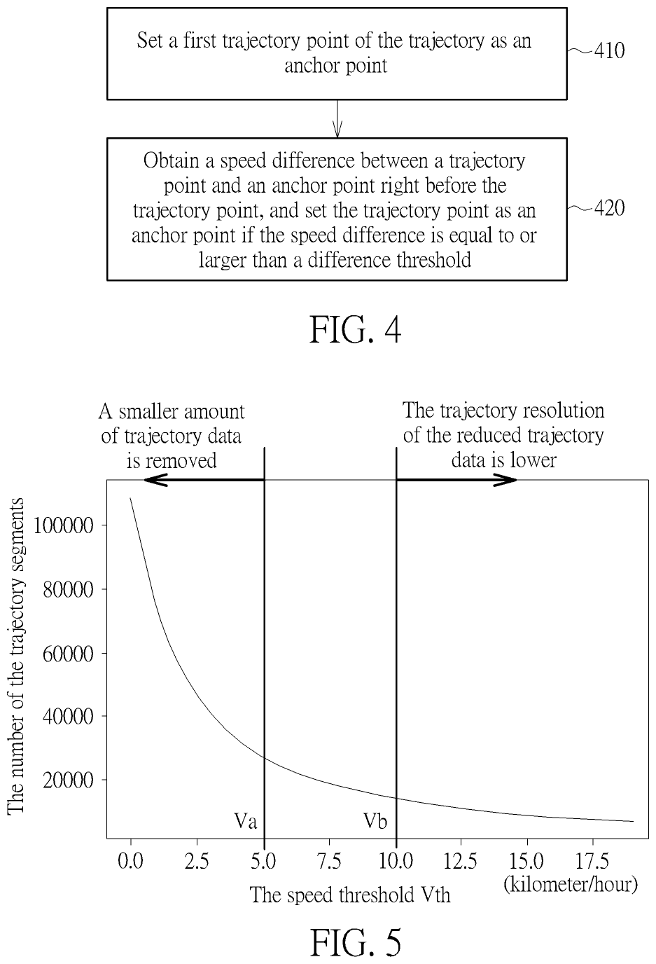

FIG. 4 illustrates a flowchart of determining the anchor points from the plurality of trajectory points in FIG. 1. The flow in FIG. 4 can be related to Step 130 of FIG. 1. Taking the example of FIG. 2 and FIG. 3, the flow of FIG. 4 can include the following steps.

Step 410: set a first trajectory point P1 of the trajectory as an anchor point A1; and

Step 420: obtain a speed difference between a trajectory point and an anchor point right before the trajectory point, and set the trajectory point as an anchor point if the speed difference is equal to or larger than a difference threshold.

In the example of FIG. 2 and FIG. 3, in Step 410, the first trajectory point P1 of the trajectory data 200 can be set as the anchor point A1. In Step 420, the speed V2 corresponding to the trajectory point P2 can subtract the speed V1 corresponding to the anchor point A1 (i.e. the trajectory point P1) right before the trajectory point P2 to generate a speed difference (i.e. V2−V1). It can be checked whether the speed difference (V2−V1) is larger than or equal to a difference threshold (expressed as Vth). In the example of FIG. 2 and FIG. 3, because the speed difference (V2−V1) is smaller than the difference threshold Vth (i.e. V2−V1<Vth), the trajectory point P2 is not set as an anchor point. Likewise, because the speed difference (V3−V1) between the speed V3 corresponding to the trajectory point P3 and the speed V1 of the anchor point A1 right before the trajectory point P3 is also smaller than the difference threshold Vth (i.e. V3−V1<Vth), the trajectory point P3 is not set as an anchor point either.

Then, the next trajectory point P4 can be checked. Because the speed difference (V4−V1) between the speed V4 corresponding to the trajectory point P4 and the speed V1 of the anchor point A1 right before the trajectory point P4 is larger than or equal to the difference threshold Vth (i.e. V4−V1≥Vth), the trajectory point P4 is set as an anchor point A2.

After determining the anchor point A2, likewise, the speed V5 corresponding to the trajectory point P5 can subtract the speed V4 of the anchor point A2 right before the trajectory point P5 to generate the speed difference (V5−V4). Because the speed difference (V5−V4) is smaller than the difference threshold Vth (i.e. V5−V4<Vth), the trajectory point P5 is not set as an anchor point. Likewise, the trajectory points P6 and P7 are not set as anchor points.

Then, the speed V8 corresponding to the trajectory point P8 can subtract the speed V4 of the anchor point A2 right before the trajectory point P8 to generate the speed difference (V8−V4). Because the speed difference (V8−V4) is larger than or equal to the difference threshold Vth (i.e. V8−V4≥Vth), the trajectory point P8 is set as the anchor point A3.

The rest can be deduced by analogy, if a speed difference between the speeds of a trajectory point and an anchor point right before the trajectory point is larger than or equal to a difference threshold, the trajectory point can be set as an anchor point. Otherwise, the trajectory point is not set as an anchor point.

According to a large amount of real data collected, different difference thresholds Vth can be used to obtain different numbers of trajectory segments and anchor points, and the graph such as FIG. 5 can be obtained. An appropriate value (e.g. a value between 5 and 10) can be selected according to the graph like FIG. 5 to be the difference threshold Vth, and the selected difference threshold Vth can be a fixed value.

Given a smaller difference threshold Vth, the higher the trajectory resolution of the updated trajectory data, and a smaller amount of trajectory data may be removed. For example, if the difference threshold Vth is smaller, the speed difference of a trajectory point and an anchor point right before the trajectory point is more likely to be larger than the difference threshold Vth. Hence, if the difference threshold Vth is smaller, more trajectory points can be set as anchor points, the number of trajectory segments can be larger, and more anchor points can be retained in the reduced trajectory data. As a result, the trajectory resolution of the updated trajectory data can be higher, but only a smaller amount of trajectory data can be removed.

FIG. 5 illustrates the relationship between the speed threshold Vth and the number of the trajectory segments according to an embodiment. As shown in FIG. 5, when the speed threshold Vth is lower than a reference value Va, the number of the trajectory segments is larger, and a smaller amount of trajectory data is removed. When the speed threshold Vth is higher than a reference value Vb, the number of the trajectory segments is smaller, and a larger amount of trajectory data is removed, however, the trajectory resolution of the reduced trajectory data is lower. Hence, the speed threshold Vth can be set between the reference values Va and Vb. For example, as shown in FIG. 5, the reference values Va and Vb can be 5 km/hour (kilometers per hour) and 10 km/hour respectively. The speed threshold Vth and the number of the trajectory segments shown in FIG. 5 is an example, and embodiments are not limited thereto.

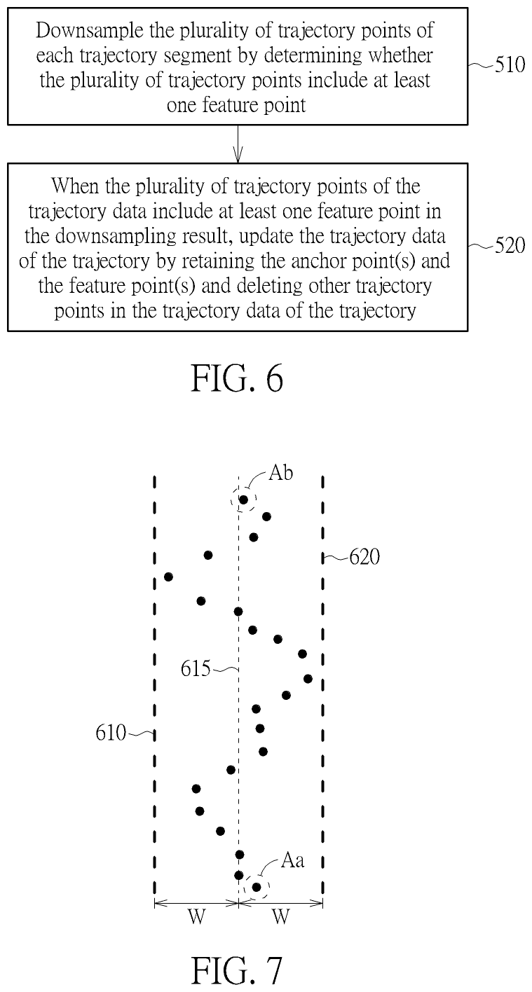

FIG. 6 illustrates a flowchart of downsampling each trajectory segment to retain or delete trajectory points according to an embodiment. The flow of FIG. 6 can be related to Steps 150 and 160 of FIG. 1. Taking FIG. 2 and FIG. 3 as an example, the flow of FIG. 6 can include the following steps.

Step 510: downsample the plurality of trajectory points of each trajectory segment (i.e. each of the trajectory segments S1 to S4) by determining whether the plurality of trajectory points include at least one feature point; and

Step 520: when the plurality of trajectory points of the trajectory data include at least one feature point in the downsampling result, update the trajectory data of the trajectory by retaining the anchor point(s) and the feature point(s) and deleting other trajectory points in the trajectory data of the trajectory.

In the example of FIG. 2 and FIG. 3, in Steps 510 and 520, since the trajectory point P14 is determined to be the feature point F1, the trajectory point P14 can be retained. Since the trajectory points P2, P3, P5 to P7, P9 to P11, P13, P15 and P16 are determined not to be feature points, these trajectory points can be deleted. In FIG. 2 and FIG. 3, the trajectory point P14 deviates further away from a path between the anchor points A4 and A5, so the trajectory point P14 is determined to be the feature point F1 and retained. The determination of a feature point is described as below.

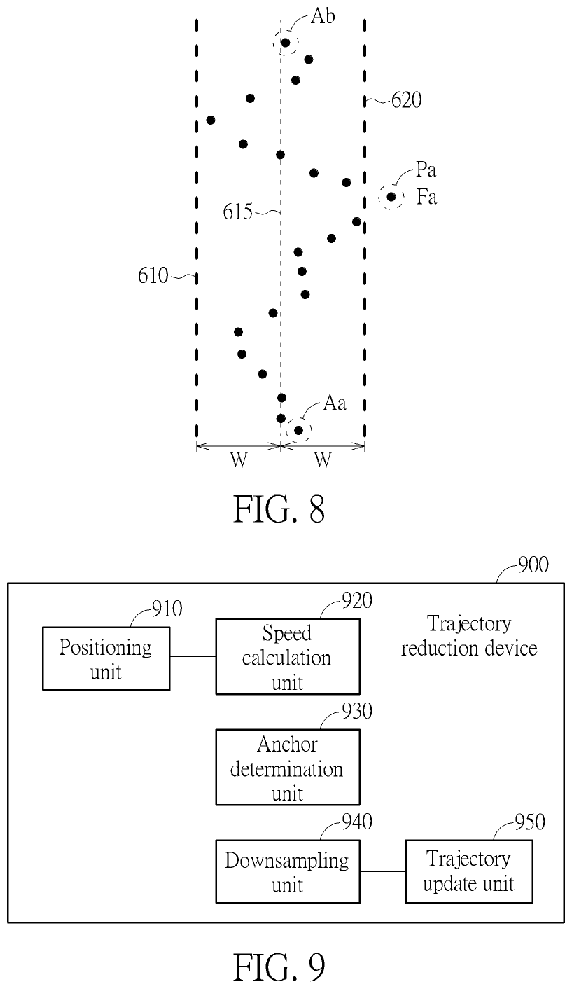

In Step 510, the plurality of trajectory points can be downsampled using a resolution threshold (e.g. the width W mentioned below) to determine whether the trajectory points include at least one feature point. In Step 510, a trajectory point outside a predetermined range can be set as a feature point, where the predetermined range can be related to a trajectory segment. Examples are provided as shown in FIG. 7 and FIG. 8.

FIG. 7 illustrates an example where the trajectory points are within a predetermined range (e.g. road range). As shown in FIG. 7, the road width of a road is the width between the reference lines 610 and 620, and a reference line 615 can be in the middle between the reference lines 610 and 620. The width between the reference lines 610 and 615 is the width W, and the width between the reference lines 615 and 620 is also the width W. Generally, the width of a road is at least 3.25 meters. For example, if the width of the road shown in FIG. 7 is 3.25 meters, the width W can be 1.625 meters.

In FIG. 7, the plurality of trajectory points can be of a trajectory segment between the anchor points Aa and Ab, and the trajectory points between the anchor points Aa and Ab are not outside the predetermined range (e.g. a range between the reference lines 610 and 620), so the trajectory points can be determined not to be feature points. When Steps 510 and 520 are performed, none of the trajectory points between the anchor points Aa and Ab are determined to be a feature point or an anchor point, so the trajectory points can be deleted.

FIG. 8 illustrates an example where one trajectory point is outside the predetermined range while other trajectory points are within the predetermined range. As shown in FIG. 8, a trajectory point Pa is outside the road range, so the trajectory point Pa can be set as a feature point Fa, so the feature point Fa can be retained.

In other words, in FIG. 7, the trajectory points between the anchor points Aa and Ab can be regarded as being located on the same path with little deviation, and the speed changes among the trajectory points are smaller than a predetermined threshold, so the trajectory points can be omitted to reduce the trajectory data. In the example of FIG. 8, since the trajectory point Pa deviates further away from the path, the trajectory point Pa (i.e. Fa) can be retained in the reduced trajectory data to reflect the change of the trajectory.

In FIG. 7 and FIG. 8, if the width W is set narrower, the trajectory points are more likely to be outside the predetermined range and be determined as feature points. The width W can be regarded as a resolution threshold. If the resolution threshold is lower, the number of feature points can be larger, and the reduction of data is more limited. As shown in FIG. 7 and FIG. 8, the resolution threshold can be determined according to an average road width of a road on which the trajectory is located.

According to an embodiment, a set of iterative operations can be performed to determine whether a plurality of trajectory points are outside the predetermined range (e.g. the range between the reference lines 610 and 620), and set each trajectory point (e.g. the point Pa) outside the predetermined range as a feature point. The predetermined range can be larger if the resolution threshold is greater.

The abovementioned iterative operation is as below. Taking FIG. 8 as an example, after obtaining the feature point Fa (i.e. Pa), a new trajectory segment can be set between the anchor point Aa and the feature point Fa. Then, it can be checked if the trajectory points between the anchor point Aa and the feature point Fa are outside a new predetermined range between the anchor point Aa and the feature point Fa: if so, the point(s) outside the new predetermined range can be set as feature point(s) and retained for further adjusting the updated trajectory data; otherwise, the points can be deleted for reducing data. Likewise, the trajectory points between the anchor point Ab and the feature point Fa can be checked iteratively, and be retained or deleted accordingly. In a similar way, trajectory points between a feature point and an anchor point or between two feature points can be checked repeatedly in the iterative manner to be retained or deleted.

According to an embodiment, a Ramer-Douglas-Peucker (RDP) algorithm can be performed to determine whether a plurality of trajectory points include at least one feature point. The resolution threshold (e.g. the width W of FIG. 7 and FIG. 8) can be a distance dimension parameter of the Ramer-Douglas-Peucker algorithm. As shown in the examples of FIG. 7 and FIG. 8, the distance dimension parameter of the Ramer-Douglas-Peucker algorithm can be a design parameter which is determined according to road width restrictions of each area.

FIG. 9 illustrates a trajectory reduction device 900 according to an embodiment. The trajectory reduction device 900 can include a positioning unit 910, a speed calculation unit 920, an anchor determination unit 930, a downsampling unit 940, and a trajectory update unit 950. The operation of the trajectory reduction device 900 is described below by taking FIG. 2 and FIG. 3 as an example.

The positioning unit 910 can be used to collect a plurality of trajectory points (e.g. P1 to P17) of trajectory data (e.g. 200) of a trajectory.

The speed calculation unit 920 can be linked to the positioning unit 910 and be used to calculate speeds (e.g. V1 to V17) of the trajectory points of the trajectory data.

The anchor determination unit 930 can be linked to the speed calculation unit 920, and be used to determine at least one anchor point (e.g. A1 to A5) from the plurality of trajectory points (e.g. P1 to P17) according to speeds (e.g. V1 to V17) of the plurality of trajectory points, and divide the trajectory into at least one trajectory segment (e.g. S1 to S4) according to the obtained at least one anchor point (e.g. A1 to A5). For example, the anchor determination unit 930 can be used to perform the flow of FIG. 4 to determine anchor points (e.g. A1 to A5).

The downsampling unit 940 can be linked to the anchor determination unit 930 and be used to downsample a plurality of trajectory points of each trajectory segment to generate a downsampling result. For example, the downsampling unit 940 can be used to perform Step 510 in FIG. 6 to determine whether a plurality of trajectory points include at least one feature point. According to an embodiment, the downsampling unit 940 can be used to iteratively determine whether a plurality of trajectory points of a trajectory segment (e.g. each of S1 to S4) are outside a predetermined range, and set a trajectory point outside a predetermined range as a feature point (e.g. F1), wherein the predetermined range can be wider when a resolution threshold (e.g. W of FIG. 7 and FIG. 8) is larger.

The trajectory update unit 950 can be linked to the downsampling unit 940, and be used to at least retain the at least one anchor point (e.g. A1 to A5) according to the downsampling result to update the trajectory data (e.g. 200) to generate the updated trajectory data (e.g. 300). For example, the trajectory update unit 950 can be used to perform Step 520 of FIG. 6. When the downsampling result indicates the plurality of trajectory points include at least one feature point (e.g. F1, that is P14), the trajectory update unit 950 can update the trajectory data (e.g. 200) by retaining the at least one anchor point (e.g. A1 to A5) and the at least one feature point (e.g. F1) and deleting other trajectory points (e.g. P2 to P3, P5 to P7, P9 to P11, P13, P15 and P16) in the trajectory data (e.g. 200) so as to generate the updated trajectory data (e.g. 300).

According to an embodiment, the trajectory reduction device 900 can be implemented in an application specific integrated circuit (ASIC), a processor and/or a controller. The trajectory reduction device 900 can be installed in an automotive computer, a mobile device, a tablet computer, a server and so on, and be used with appropriate control programs.

In summary, the speed-based trajectory reduction method 100 and the trajectory reduction device 900 can effectively reduce trajectory data of a trajectory. The amount of data stored, processed and transmitted can be reduced, while the information related to speed is appropriately preserved. According to an embodiment, the trajectory reduction device 900 can be installed at an edge terminal such as a vehicle terminal to perform an edge calculation so as to reduce bandwidth usage and cloud computing. According to an embodiment, the deleted trajectory points are corresponding to smaller location changes and speed changes, so the accuracy of the reduced trajectory data is avoided from being too low. For example, compared to the original trajectory data, the reduced trajectory data generated using the trajectory reduction method 100 and the trajectory reduction device 900 can be reduced by 60% to 80% of the amount of the original data. In other words, the amount of the reduced trajectory data can be 20% to 40% of the amount of the original trajectory data. However, the difference of the trajectory lengths of the reduced trajectory data and the original trajectory data can be less than 1%, and the difference of the average speeds of the reduced trajectory data and the original trajectory data can be less than 3%. Hence, the amount of data can be effectively reduced while the accuracy of information is kept sufficient. Since the reduced trajectory data includes the speed information, the data is highly useful for subsequent analysis. For example, if map data with elevation information is used together, since the reduced trajectory data includes the speed information, the relationship of elevation and speed can be obtained. Moreover, the acceleration information of the moving object (e.g. vehicle) can be obtained according to the speed information, and the moving states and road conditions can be analyzed accordingly. Therefore, the speed-based trajectory reduction method 100 and the trajectory reduction device 900 can provide solutions to solve the problems in the field.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A trajectory reduction method, comprising:
obtaining trajectory data of a trajectory, wherein the trajectory data comprises a plurality of trajectory points;
obtaining a speed of each trajectory point of the trajectory data;
determining at least one anchor point from the plurality of trajectory points according to speeds of the plurality of trajectory points;
dividing the trajectory into at least one trajectory segment according to the at least one anchor point;
downsampling a plurality of trajectory points of each trajectory segment to generate a downsampling result; and
updating the trajectory data of the trajectory by retaining at least the at least one anchor point in the trajectory data of the trajectory according to the downsampling result.

2. The trajectory reduction method of claim 1, wherein:
downsampling the plurality of trajectory points of each trajectory segment, comprising determining whether the plurality of trajectory points comprise at least one feature point; and
when the plurality of trajectory points comprise at least one feature point in the downsampling result, updating the trajectory data of the trajectory by retaining the at least one anchor point and the at least one feature point and deleting other trajectory points in the trajectory data of the trajectory.

3. The trajectory reduction method of claim 1, wherein determining the at least one anchor point from the plurality of trajectory points according to the speeds of the plurality of trajectory points, comprises:
setting a first trajectory point of the trajectory as an anchor point;
obtaining a speed difference between a trajectory point and an anchor point right before the trajectory point; and
setting the trajectory point as an anchor point if the speed difference is equal to or larger than a difference threshold.

4. The trajectory reduction method of claim 1, wherein downsampling the plurality of trajectory points of each trajectory segment, comprises determining whether the plurality of trajectory points comprise at least one feature point according to a resolution threshold.

5. The trajectory reduction method of claim 4, wherein determining whether the plurality of trajectory points comprise the at least one feature point according to the resolution threshold, comprises performing a Ramer-Douglas-Peucker algorithm on the plurality of trajectory points to determine whether the plurality of trajectory points comprise the at least one feature point, wherein the resolution threshold is a distance dimension parameter of the Ramer-Douglas-Peucker algorithm.

6. The trajectory reduction method of claim 4, wherein determining whether the plurality of trajectory points comprise the at least one feature point according to the resolution threshold, comprises iteratively determining whether the plurality of trajectory points are outside a predetermined range, and setting a trajectory point outside the predetermined range as a feature point, wherein the predetermined range is wider when the resolution threshold is larger.

7. The trajectory reduction method of claim 4, wherein the resolution threshold is determined according to an average road width of a road on which the trajectory is located.

8. A trajectory reduction device, comprising:
a positioning unit, configured to collect a plurality of trajectory points of trajectory data of a trajectory;
a speed calculation unit, linked to the positioning unit, and configured to calculate a speed of each trajectory point of the trajectory data;
an anchor determination unit, linked to the speed calculation unit, and configured to determine at least one anchor point from the plurality of trajectory points according to speeds of the plurality of trajectory points, and divide the trajectory into at least one trajectory segment according to the at least one anchor point;
a downsampling unit, linked to the anchor determination unit, and configured to downsample a plurality of trajectory points of each trajectory segment to generate a downsampling result; and
a trajectory update unit, linked to the downsampling unit, configured to update the trajectory data by retaining at least the at least one anchor point in the trajectory data of the trajectory according to the downsampling result.

9. The trajectory reduction device of claim 8, wherein:
the downsampling unit determines whether the plurality of trajectory points comprise at least one feature point; and
when the plurality of trajectory points comprise at least one feature point in the downsampling result, the trajectory update unit updates the trajectory data by retaining the at least one anchor point and the at least one feature point and deleting other trajectory points in the trajectory data of the trajectory.

10. The trajectory reduction device of claim 8, wherein:
the anchor determination unit sets a first trajectory point of the trajectory as an anchor point, obtains a speed difference between a trajectory point and an anchor point right before the trajectory point, and sets the trajectory point as an anchor point if the speed difference is equal to or larger than a difference threshold.

11. The trajectory reduction device of claim 8, wherein:
the downsampling unit determines whether the plurality of trajectory points comprise at least one feature point according to a resolution threshold.

12. The trajectory reduction device of claim 11, wherein:
the downsampling unit performs a Ramer-Douglas-Peucker algorithm on the plurality of trajectory points to determine whether the plurality of trajectory points comprise the at least one feature point, and the resolution threshold is a distance dimension parameter of the Ramer-Douglas-Peucker algorithm.

13. The trajectory reduction device of claim 11, wherein:
the downsampling unit iteratively determines whether the plurality of trajectory points is outside a predetermined range, and sets a trajectory point outside the predetermined range as a feature point, wherein the predetermined range is wider when the resolution threshold is larger.

14. The trajectory reduction device of claim 11, wherein:
the resolution threshold is determined according to an average road width of a road on which the trajectory is located.
